(19) United States
(12) Patent Application Publication
(10) Pub. No.: US 2010/0062390 A1
(43) Pub. Date: Mar. 11, 2010

(54) CORDLESS PRE-CALIBRATED TORQUE DRIVER WITH ABUTMENT HOLDER FOR IMPLANT PROSTHETICS AND METHODS OF USE

(76) Inventor: Boaz Hetsroni, Haifa (IL)

Correspondence Address: Pearl Cohen Zedek Latzer, LLP, 1500 Broadway, 12th Floor, New York, NY, 10036, US

(21) Appl. No.: 12/524,945

(22) PCT Filed: Feb. 3, 2008
(86) PCT No.: PCT/IL08/00138

§ 371 Date: Jul. 29, 2009

Related U.S. Application Data
(60) Provisional application No. 60/989,743, filed on Nov. 21, 2007.

(51) Int. Cl. A61C 3/02; B65D 85/24

(52) U.S. Cl. 433/75; 206/338

(57) ABSTRACT

A cordless pre-calibrated torque driver with a detachable abutment holder for driving prosthetics on dental implants. The main object of the present invention is to provide a portable cordless driver for prosthetics on implants with a pre-calibrate torque. The pre-calibrated torque is achieved by a special embodied mechanism on the motor shaft. Another object of the present invention is to provide a portable pre-calibrated torque driver with a detachable abutment holder, which prevents torque delivery to the implant whenever an abutment is tightened or released from it. The holder also enables easy access to posterior implants and one sole hand practice. For that purpose, the present Invention further provides for an organizing device designed to be used along with a cordless driver that can unload the healing caps from the driver. Using a single hand, a dentist can quickly load and unload healing caps from implants to said organizer and back, and abutments with an attached holder from laboratory model to implants and back and without risking implant stability in the bone by torque delivery from the driver (typically 25 Ncm). These devices and methods significantly reduce chair time needed to restore dental implants and contribute to improve success rates of implants.

### CROSS REFERENCE TO RELATED APPLICATIONS

This application claims the benefit under 35 USC 119(e) from U.S. provisional application 60/898,743 filed Feb. 1, 2007, the disclosure of which is included herein by reference.

### FIELD OF THE INVENTION

The present invention generally relates to devices for dental implants, and more particularly to devices with pre-calibrated torque and with an abutment holder for driving prosthetics on implants and methods of use.

### BACKGROUND OF THE INVENTION AND PRIOR ART

The term “handpiece” is a generic and euphemistic term for generic dental tools. A dental handpiece is typically held and operated by a dentist with a sole hand. The terms “driver”, “handpiece”, “dental handpiece”, “contra angle handpiece” and “latch head” are used herein interchangeably. The driver as used herein also uses a contra angle head to accept latch burs.

The term “prosthetic screw” as used herein refers to screws used to attach various abutments, healing caps and copings to implants or their analogues, and “prosthetics” is the procedure of using those parts.

The term “driver tip” as used herein refers to interface of latch bur that are held and operated by a dental latch head handpiece and are suitable and fit to various prosthetic screw heads. A driver tip is also known as “chuck”.

Today, dentists are using a hand driver for implant prosthetics and then a manual pre calibrated torque wrench to fasten the screws. FIG. 1 depicts an example of a pre-calibrated torque wrench of prior art and FIG. 2 depicts an example of an abutment holder of prior art, which are too weak to prevent rotation torque from an implant when applied by any kind of driver. While using a driver to fasten the abutment screw, a separate tool—an abutment holder, such as abutment holder 80, is also used to hold and position abutments, especially for posterior implants where there are limited access and poor visibility. FIG. 3 illustrates a side view of an abutment 50, having a hexagonal base 54, designed for internal hex implant. FIG. 4 depicts a latch driver tip 40 to fit screw head 53 (usually hex), an abutment 50 and abutment screw 52, and FIG. 5 illustrates the pre-calibrated torque wrench 20 shown in FIG. 1, operatively used to tighten abutment 50 to implant hex 60. FIG. 5 illustrates implant 60 (internal hex) with hexagonal cavity 62, into which the hexagonal base 54 of abutment 50 is inserted. When driver 15, with/without torque wrench 20, tightens screw 52 in clockwise direction 41, abutment 50 deliver the torque 41 to the implant hex 62. Similarly, the torque force is also transferred in a releasing action in the opposite direction.

While doing prosthetics on implants, the dentist needs to exchanges the healing caps (or healing abutments) with abutments prepared on a stone model. Generally, this try-in process is repeated several times, till a final satisfactory restoration can be delivered to the patient.

Furthermore, when healing caps are removed from the implants, the per-implanter tissue tends to cover implants edge in a minute, so it is important to work quickly, without losing the healing caps order or having dislodgements from the hand driver.

Another problem arises when using hand drivers: the dentist hand which is in or in front of the patient's mouth obscures his field of view. The “prosthetic parts driver for easy access to posterior implants” (SALVIN, USA-2006 catalogue) is built as a contra angle manual handpiece to cope with that problem, but it requires both hands and thus, even an abutment holder cannot be used at the same time and a torque wrench is still needed separately.

When trying to seat abutments for a fabricated bridge on posterior implants (try-in), access is difficult. Usually, assistance is required by an abutment holder. For example, U.S. Pat. No. 6,471,515, given to Feuer, describes an abutment holder. This tool's grasping force is very limited like other existed today is used just to help to correctly position the abutment on the implant hex, with no connection to the action of screwing in the abutment screw, There is therefore a need, and it would be highly advantageous to use easier and time consuming techniques for holding an abutment while driving its screw on implant.

Tightening an abutment to a fixture is done with a pre-calibrated torque wrench. The most popular wrench 20 with a preset torque is “DynaTorque wrench” (depicted in FIG. 1). “3i” and “Antogyr” have manual contra angle preset torque wrench. The recommended torque value for tightening an abutment screw is usually 25 Ncm. (To open, an extra torque of 3-5 Ncm is needed.) There is a strong debate on the accuracy of wrenches after prolonged usage (Accuracy of implant torque wrench following time in clinical service, Int J Prosthodontics 1997 November-December; (6):562-7). It should be noted that the torque applied by any a hand driver or a wrench on the abutment screw, during tightening or releasing it, is delivered thoroughly to the connected implant, since the abutment tries to rotate inside the implant hex (internal hex). This action can cause, especially in early loading of an implant, at least a partial failure of the osseo-integration, means the connection in the bone-implant interface since micro-fractures of this biological connection might happen from that. To avoid this problem, dentists usually use lighter forces when tightening abutment screws in the prosthetic phase.

A pre-calibrated torque motor for prosthetics does not exist yet. Phisio-dispensers and endo torque devices are “torque controlled” by current changing (motor halt at once). This mechanism is not accurate like a “pre-calibrated torque” which is one accurate value sensed from the screw at distal end of shaft, that limits the torque delivered while motor still rotating (same principle as in the manual device) Similarly, “Nobelbiocare” presents with a drilling unit, Osseoset 200, that might work for tightening prosthetics with variable speeds and torque control—again, neither the pre-calibrated torque nor the method of this invention.

U.S. Pat. No. 6,607,385, given to Sevcik et al, provides a method and a device added to an existing dental and surgical handpiece for limiting the torque to a preset force. The suggested device is a whirred device (an outer, not embodied mechanism) designed for screwing in implants (not for prosthetics), without the intention to cope with posterior abutment access, nor using any holder.

Single hand technique for driving prosthetics on implants requires an electrical cordless preset torque driver. Today, only endodontic cordless devices like Endomate TC (“NSK”), and. TRI auto ZX (“J. Morita”) exist in the market. They use a geared latch head with a plastic body. Like many other endo torque devices they have “torque control” and auto-reverse mechanism. While TRI lacks a “start button” on the handpiece neck, the Endomate is operated by one momentary finger key (forward)—not two independent (forward and reverse) as provided by the present invention. Both devices use rechargeable batteries and own a control panel on the rear plastic body to determine torque (values are too small for prosthetics) and speed, depending on the endodontic file used, resistance, etc.

U.S. Pat. No. 4,355,977, given to Ota et al, and U.S. Pat. No. 4,619,614, given to Baba et al, are examples of improvements to cordless dental handpieces with batteries storage and an incorporated electric motor for other than implant treatment, so torque and speed do not suit driving prosthetics on implants.

There is therefore a need for a cordless preset torque tool for driving prosthetics quickly by sole hand in one step.

During the prosthetic stage for dental implants the dentist takes the healing caps off the implants and places them in patient's tray, while trying to keep them in order. One hand method requires a special organizer to load and unload the healing caps with the driver.

Prior art devices offer various trays such as described in WO0057810, given to Kvarnstroem Bjarne et al, WO2004100819, given to Barnes Richard, GB1507325 given to Kaj Backstrom et al, and others. None of the prior art tray devices are designed to firmly hold healing caps by matching the healing caps threads and/or the abutment holder that is part of this invention.

There is therefore a need for a dentist using a single hand technique to have an organizing tool that unloads/loads healing caps from/to the driver, thus enable fast exchanging with abutments before the gums partially cover the implants.

### SUMMARY OF THE INVENTION

The principal intention of the present invention includes providing a cordless preset torque driver, with a detachable abutment holder for driving prosthetics quickly onto and from implants in the limited space of a human being mouth.

An aspect of the present invention is to provide a cordless prosthetic parts driver with a detachable abutment holder to ease access and allow a single hand technique. The abutment holder provided by the present invention functions simultaneously with the driver. The simultaneous use of the driver band the abutment holder enables a single hand practice with abutments and improves the access to the inner teeth implants.

According to the teachings of the present invention a cordless, contra angle, pre-calibrated torque prosthetic parts driver for dental implants is provided. The driver includes: (a) an electric motor with gear mechanism; and (b) A latch head capable of holding a latch bur with various tips operatively adaptive to various prosthetic screw heads to various driver lengths matching various heights of abutments; and (c) a pre-calibrated torque mechanism having a preset torque value. The electric motor with gear mechanism is capable of turning the latch head in forward and backward directions.

The present invention further includes an abutment holder, preferably detachable, that enables driving abutments with a single hand technique without transferring torque to the implants. The abutment holder includes a mechanism for grasping an abutment and a mechanism for attaching the holder to the driver latch head. The grasping mechanism firmly holds an abutment and prevents the abutment from rotating, and thereby prevents the transfer of torque forces from the abutment to a coupled implant, when the abutment is being driven into the implant or out of the implant.

The present invention further provides, as part of the single hand method, an organizing device that includes orderly tapped holes with various screw threads, to hold healing caps and/or healing abutments.

The pre-calibrated torque mechanism includes two discs, two latches in grooves and a retaining spring ring. The spring ring holds the discs together and sets, together with the shape of the grooves, a single pre-calibrated torque value, thereby preventing a prosthetic screw from being tightened with a force surpassing the pre-calibrated torque value, and wherein when the tightening force reaches the preset torque value, the latches overcome the force applied by the retaining spring ring thereby disengaging the two discs, and thereby causing a temporary separation of the latch head shaft from the driver motor shaft.

Using the cordless driver of the present invention together with the organizer of the present invention, the dentist, by one hand, can load and unload healing caps between patient's mouth and the organizer, and abutments between the laboratory model and the implants with a preset torque.

The driver of the present invention replaces three prior art devices: a hand/manual driver; an abutment holder, which requires a second hand; and a manual pre-calibrated torque wrench,

The driver provides an easier access to posterior fixtures. Compared to the using of a hand driver with a regular abutment holder, driver tip here is already within the screw of a grasped abutment, so only 20 mm of vertical space is needed for mounting the abutment onto a vacant implant, while even when using the shortest hand driver, the fingers used and the abutment height require more than 30 mm of space above the fixture.

Hence, one aspect of the present invention is to provide a cordless, contra angle driver for driving prosthetic parts, especially on posterior implants with a pre-calibrated torque. The pre-calibration is done by a special embodied mechanism.

Another aspect of the present invention is to provide a cordless prosthetic parts driver with abutment holder to ease access and allow safer sole hand techniques.

An aspect of the present invention is to provide a tool that will “hold and release” healing caps in a certain order, during prosthetic procedures, thus allow for a single hand method.

The pre-calibrated torque driver may also be used with a straight nose cone (better access to areas like anterior maxilla).

The drivers of the present invention typically use an electric motor, typically powered by batteries, placed in a battery compartment and hence the driver is referred to as a cordless driver. But the present invention is not limited to a batteries powered motor and the driver of the present invention can be also powered by an external electric power or by compressed air, as exists in dental units.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 (prior art) depicts an example of a pre-calibrated torque wrench of prior art;

FIG. 2 (prior art) depicts an example of an abutment holder of prior art;

FIG. 3 (prior art) illustrates a side view of an abutment designed for internal hex implant, including an enlargement of the undercut area;

FIG. 4 (prior art) depicts a latched driver tip, with an abutment and the abutment screw;

FIG. 5 (prior art) illustrates the pre-calibrated torque wrench shown in FIG. 1, operatively used to tighten an abutment to the implant hex with a designated screw, optionally using a hex driver;

FIG. 6 illustrates a cordless pre-calibrated torque driver with mini latch head, according to an embodiment of the present invention;

FIG. 7 illustrates a cordless pre-calibrated torque driver with a straight nose cone, according to an embodiment of the present invention;

FIG. 8a is a side perspective view illustration of an abutment holder, according to the preferred embodiment of the present invention;

FIG. 8b is a top perspective view illustration of the abutment holder, shown in FIG. 8a;

FIG. 8c is a bottom view illustration of the abutment holder, shown in FIG. 8a;

FIG. 9 illustrates the cordless pre-calibrated torque driver shown in FIG. 6, with the abutment holder, shown in FIG. 8a, attached to the driver;

FIG. 10 illustrates the cordless pre-calibrated torque driver shown in FIG. 6, with a healing cap (abutment holder detached;

FIG. 11 depicts the cordless pre-calibrated torque driver shown in FIG. 6, assembled with an abutment and the abutment holder, shown in FIG. 8a.

FIG. 12 depicts an organizer for attaching healing caps and hold other accessories, according to embodiments of the present invention;

FIG. 13 is a schematic block diagram illustrating the usage of the driver with the organizer, according to an embodiment of the present invention;

FIG. 14 depicts a laboratory stone model of implanted jaw with two analogues and abutments;

FIG. 15 is a frontal view of the pre-calibrated torque mechanism, according to an embodiment of the present invention;

FIG. 16 is a partial cross section lateral view of the pre-calibrated torque mechanism, according to an embodiment of the present invention; and

FIG. 17 illustrates the interface between the contra angle latch head and the pre-calibrated torque mechanism, according to an embodiment of the present invention.

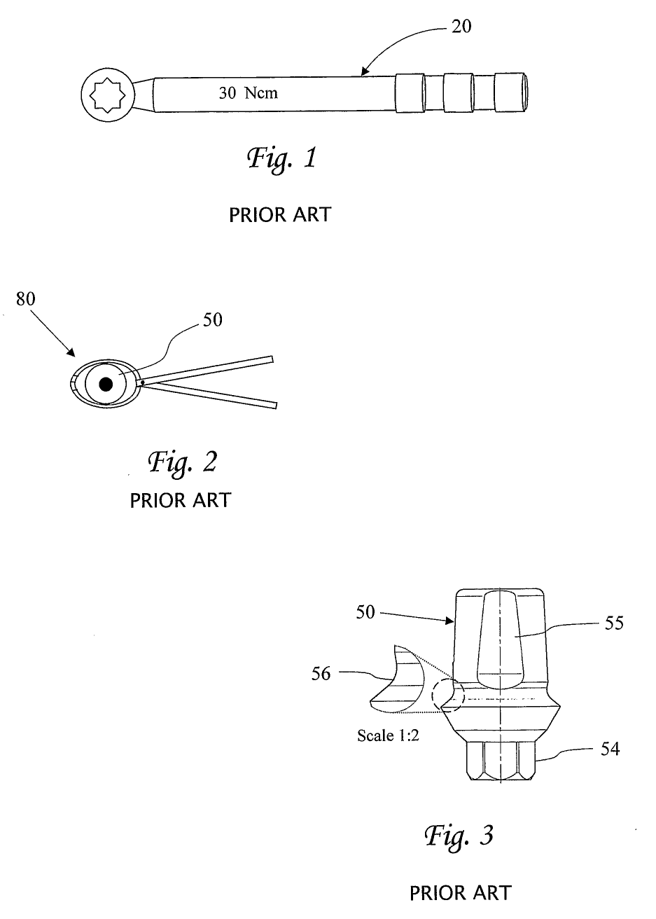

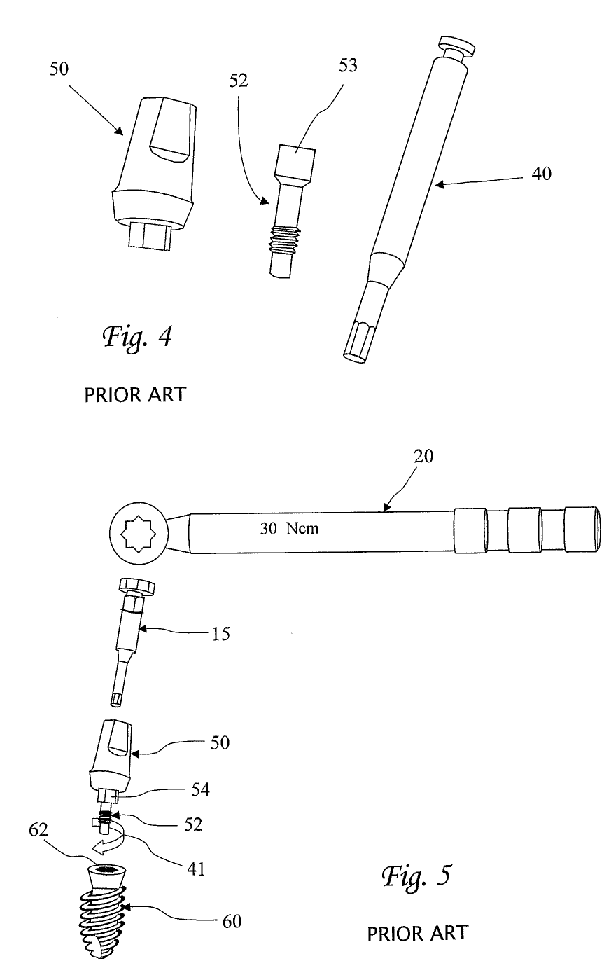

### DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided, so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The methods and examples provided herein are illustrative only and not intended to be limiting.

By way of introduction, the principal intentions of the present invention include to provide a cordless device for driving prosthetic parts on implants with a pre-calibrated torque, and a one hand method of using it. The pre-calibration is done by a special embodied mechanism. Another object of the present invention is to provide a cordless driver with an abutment holder that improves access to posterior implants.

It should be noted that regarding effectiveness, the driver of the present invention is clearly more effective than prior art drivers, since the prior art abutment holders are simple grasping tools that occupies one of the dentist's hands (while holding a conventional driver in the other), while the abutment holder of the present invention is self-held, attached to the handpiece, allowing a single-hand-technique while leaving one of the dentist's hands free for other tasks. Above all, the abutment holder protects the implant from the torque used to tighten/release the abutment screw by producing an equal anti rotational moment to counteract and absorb that torque in the connected driver's head. Furthermore, the abutment holder is a miniature tool which almost completely eliminates the problem associated with prior art practice, of worksite obscuring.

By way of introduction, other intentions of the present invention include to provide a single hand method with an organizing device that quickly unloads the healing caps from the driver. The organizing device includes orderly tapped holes with various screw threads to hold healing caps and a special compartment to load/unload the abutment holder by sole hand. The device is a supporting device for a dentist, especially when using a driver with a single hand, according to the present invention. The dentist can efficiently unload on the organizing device healing caps. For the sake of clarity, the organizing device can be used also for healing/temporary abutments and any other dental item, various driver tips, etc.

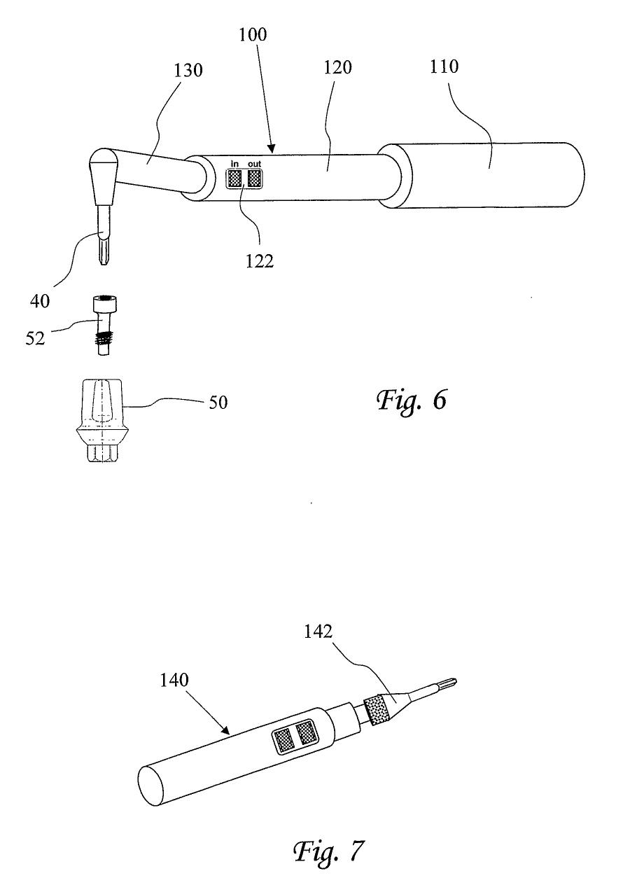

Reference is now made to the drawings. FIG. 6 illustrates cordless pre-calibrated torque driver 100 with mini latch head 130, according to embodiments of the present invention. Rear part 110 of the body of driver 100 may serve as a batteries compartment and the shape of rear part 110 can be adapted to the batteries type used. Middle part 120 of the body of driver 100 preferably contains a motor and a gear, including a pre-calibrated torque mechanism. This is the preferred arrangement but the present invention is not limited to the described arrangement. For example, the torque mechanism or gear can be built inside head 130 of device 100.

Driver 140 illustrated In FIG. 7, illustrates an option of using a straight nose cone 142 instead of contra angle, which functions as anterior upper jaw screwdriver or as orthopedic screwdriver.

As shown in FIG. 3, abutment 50 preferably includes flattened anti-rotational area 55 and small undercut area 56, two useful components for enhancing the grabbing method.

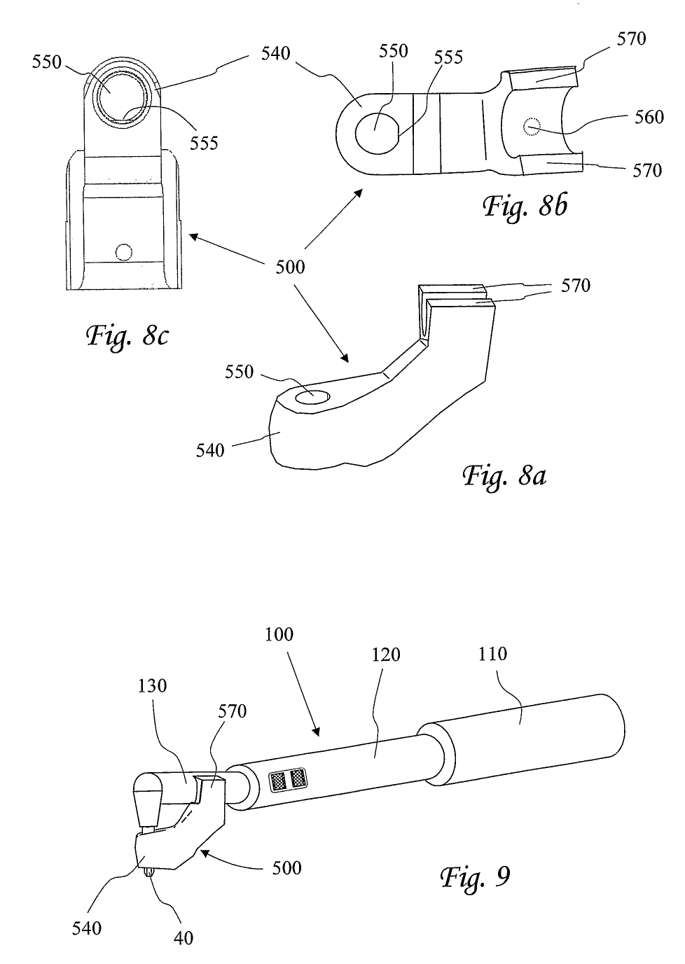

Reference is now made to FIG. 8a, which is a side perspective view illustration of abutment holder 500, according to the preferred embodiment of the present invention. FIG. 8b is a top perspective view illustration and FIG. 8c is a bottom view illustration of abutment holder 500, shown in FIG. 8a. Abutment holder 500, as well as other abutment holders, operatively stops and/or prevents the rotation of abutment 50, when being attached or detached by cordless pre-calibrated torque driver 100.

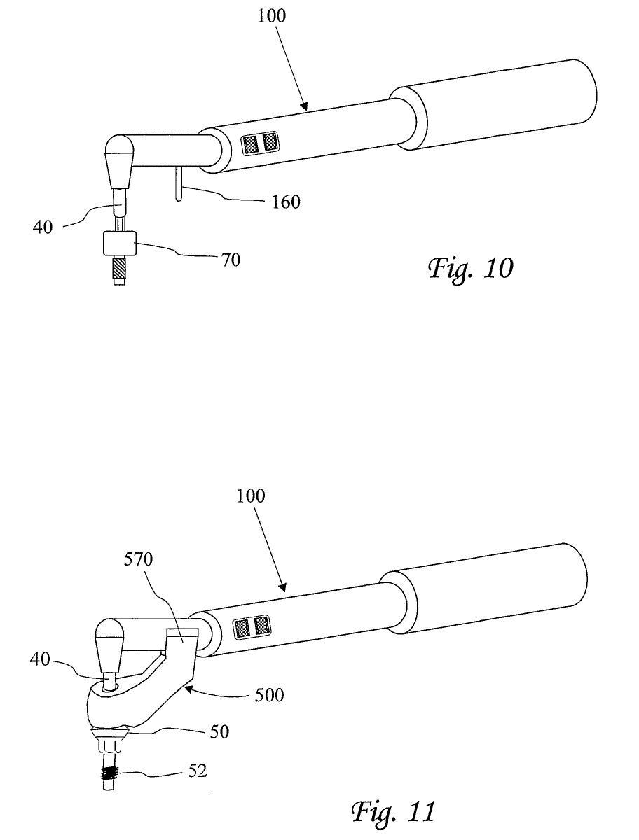

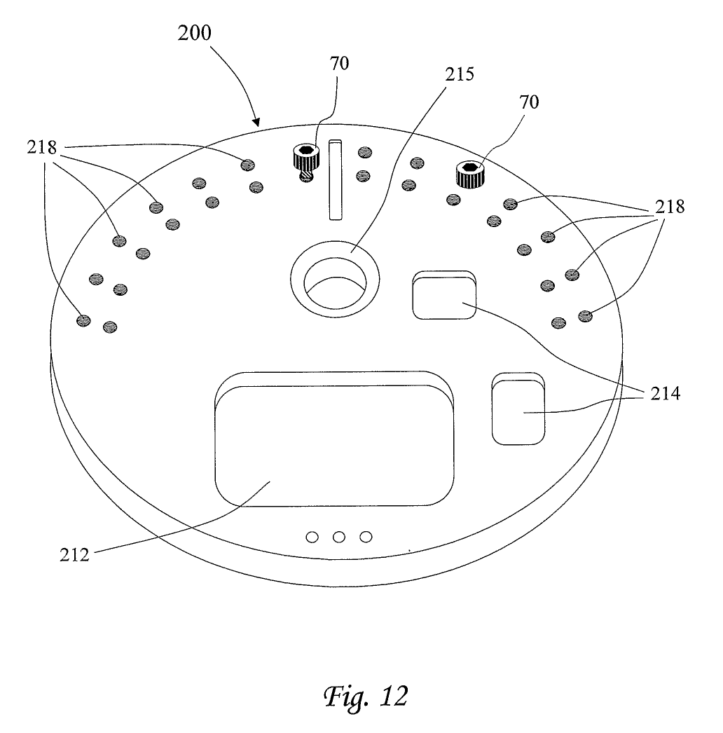

Reference is now made to FIG. 11, which illustrates cordless pre-calibrated torque driver 100, assembled with abutment 50 being held by abutment holder 500, shown in FIG. 8a. Reference is also made to FIG. 10, which illustrates cordless pre-calibrated torque driver 100, with a healing cap 70 (abutment holder not attached). When operating driver 100, the motor operatively turns either healing cap 70 or abutment screw 52 in or out (as desired), as respectively shown in FIGS. 10 and 11. The shape and/or diameter of insert 550 respectively adapted to the shape of the selected abutment 50 and to the length of the tip of driver 40 being disposed into hex cavity 53 of abutment screw 52. Hence, each abutment holder 500 is specific to each abutment 50 design. While tightening a screw 52 in direction 41 with torque driver 100, abutment holder 500 stops and prevents rotation of abutment 50. The torque pressure on flattened area 55 is transferred to fastening arms 570 which absorb the transferred torque by the contact areas with the body of driver 100. It should be noted that more than one flattened area might be in the circumference of abutment 50. Similar transfer of torque force occur when opening a tightened screw 52 with driver 100 having abutment holder 500 attached to driver 100. This principle is very useful for handling dental implants, since the torque is prevented from being transferred to the implant, unlike all other tools or methods known today, that transfer the applied torque directly to the implant, through hex 62, and risk the implant connection with the surrounding bone. The torque transferred to implant may also cause an implant to fail, especially when dealing with early loading when just part of the osseo-integration has occurred.

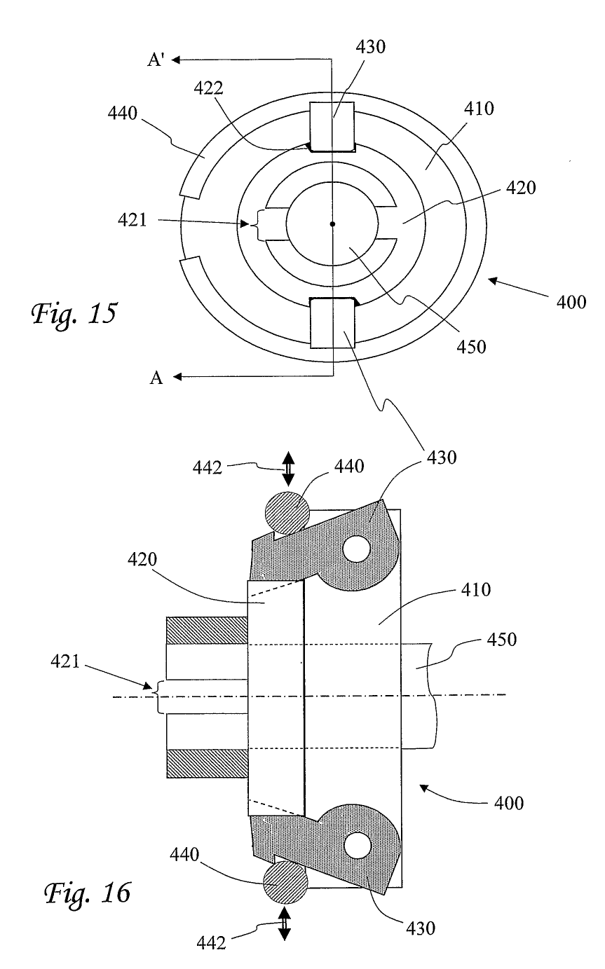

Reference is also made to FIGS. 15 and 16. FIG. 15 depicts a frontal view of pre-calibrated torque mechanism 400 including motor shaft 450 of driver 100, according to embodiments of the present invention. FIG. 16 is a partial cross section AA′ lateral view of pre-calibrated torque mechanism 400, shown in FIG. 15. When screwing in abutment 50, the first momentary press key 122 (see FIG. 6) is pressed (“in”, for example) and torque mechanism 400 terminates the spin of a screw at a preset torque force while motor 450 continues to run. When unscrewing, a separate second momentary press key 122 is pressed (“out”, for example) and the screw will receive the full motor force, due to asymmetrical shape of grooves 422 that do not allow torque limiting mechanism to operate when opening a screw. This usage of the torque force is the preferred method, but the present invention is not limited by it, and any other mechanism can be utilized, including various preset torque values in the mechanism.

The tightening/releasing method of abutment 50 enables a one hand technique. An abutment is typically located with flattened side 55 preferably pointing towards the buccal side (lips side), to allow access and fitting to flat area 555 of insert 550 direction of holder 500. Figure 14 depicts a laboratory stone model 90 of implanted jaw with two analogues 60 and abutments 50. After releasing screw 52, abutment 50 is taken from model 90, positioned and tightened as is in the patients' mouth.

Abutment holder 500 shown in FIG. 8a is given as examples only and other embodiments of such holder and attachments to latch head 130 can be designed and used.

FIG. 9 depicts driver 100 assembled with abutment holder 500, ready for operation, according to embodiments of the present invention. Abutment holder 500 is stably attached to the latch head 130 by fastening arms 570.

Optionally, abutment holders 500 include a hole 560 respectively, which is used to mount abutment holders 500 onto a corresponding pin 160 on latch head 130 (see FIG. 10), and thereby abutment 50 can be held at a proper distance from latch driver tip 40.

The operational steps of using driver 100 will now be described coupled with abutment holder 500, but the present invention in not limited by to abutment holder 500, and any other abutment holder can be designed to perform the task of stopping and/or preventing the rotation of abutment 50 and thereby prevent the transfer of torque moment to implant 60.

In embodiments of the present invention the abutment holders, such as abutment holder 500 are attachable/detachable to/from driver 100.

In embodiments of the present invention the abutment holders, such as abutment holder 500 are affixed to driver 100.

The operational steps of using driver 100 with abutment holder 500, to transfer an abutment 50 between a laboratory model 90 and patient's 10 mouth, are as follows:
a) Place the latch driver tip 40 onto screw 52 of abutment 50, while insert 550 with properly directional flattened area 555 grab flattened area 55 of abutment 50 positioned on model 90.
b) Turn on motor 450 of driver 100 in rewind direction to catch screw 52 and to release abutment 50 from model 90 and hold abutment 50. FIG. 11 illustrates driver 100, assembled with abutment 50 being held by abutment holder 500.
c) Transfer held abutment 50 to the patient's mouth maintaining respective position as on hexagonal analogue base 54 in stone model 90
d) Turn on motor 450 in forward direction to attach abutment 50 to implant 60 using the appropriate torque (typically, a clicking sound is heard when done).
e) Pull to detach device 100 from abutment 50.
f) After try—in the process is done same way vise versa.

The present invention also provides for an apparatus that facilitates an efficient, flexible and user-friendly method to take out healing caps 70 with every check of bridge structure (porcelain on metal or zirconium) in patient's mouth. Reference is also made to FIG. 12, which illustrates organizer 200, according to embodiments of the present invention. Using a single hand, the dentist loads the healing caps 70 and unloads them into special organizer 200, developed for that purpose. An organizer of the present invention can take different shapes and layouts with any number of threaded holes 218. In organizer 200, for example, the layout of threaded holes 218 are designed to simulate the mouth structure and thus enables keeping healing caps 70 in implants location order. Organizer 200 also contains compartments 212 that can hold other items and a compartment 214 to fit and catch abutment holder 500 on “abutment like” structure (possibly exchangeable) and a compartment 215 to hold the driver when not in use.

During preparation of a porcelain fused to metal bridge (or any other type), the restorative dentist needs to transfer abutments 50 from the laboratory model 90 to patient's 10 mouth and back several times, before the final restoration takes place. When trying-in the abutments 50, the dentist needs to take out healing caps 70. It should be noted that after taking out healing caps 70 from implants 60, the working time should be as short as possible, before gums partially cover the vacant implants 60. Organizer 200 helps to shorten that time.

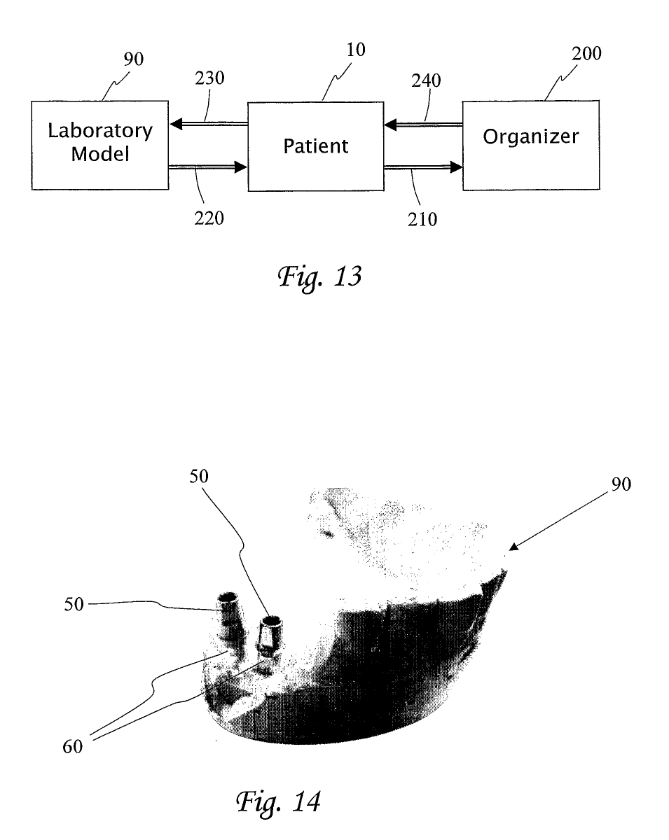

Referring to FIG. 13, a schematic block diagram illustrating the method of usage of driver 100 with organizer 200, according to an embodiment of the present invention, is shown. The restorative dentist takes (action 210) healing caps 70 out of the mouth of patient's 10, and puts them in a designated location in the organizer 200. Operating motor 450 for a second forward will position a healing cap 70 firmly in the threaded hole, so it stays there when pulling up the driver. The dentist now using device 100, attaches holder 500 from compartment 214, takes every abutment 50 from the laboratory model 90, and attaches (action 220) each abutment 50 onto a vacant implant 60. After checking and determining accuracy of abutments grinding and bridge fabrication, the process continues in a reverse order. The dentist removes abutments 50 from implants 60 and puts (action 230) them back onto laboratory model 90, using device 100 with the still attached holder 500. Then, dentist detaches holder 500 by pressing holder 500 down with the thumb and the finger on the lower edges, preferably back to compartment 214 in organizer 200. The last step is to put (action 240) healing caps 70 back from organizer 200 onto vacant implants 60. As explained, in steps 210 and 240, holder 500 is not in use and is preferably held in organizer 200 (It is useful also for autoclaving the holder).

It should be noted that when holder 500 is not needed as an anti-rotational device, for example when screwing in or out healing caps 70 (as shown in FIG. 10), which are typically made of one piece, then holder 500 is detached from head 130 by pulling down fasteners 570 using two fingers on holder 500 bottom into organizer cavity 214 with small “abutment like” pillar. Attaching holder 500 from cavity 214 in the organizer 200 to the driver 100 is done easily by one hand while pressing on fasteners 570 using neck 130 of driver 100.

When screwing an abutment screw 52 in, screw 52 spin is terminated when the torque force needed reaches the pre-calibrated torque value, as pre designed into mechanism 400. Referring to FIGS. 15 and 16, one embodiment for presetting the threshold torque force is shown, but the present invention is not limited by it, and any other mechanism known in the art can be used, including a mechanism that gives two or three preset torque values.

In this embodiment, the mechanism includes two discs (410 and 420), two latches 430 (connected with pins to disc 410), and a retaining ring 440 that presses the free ends of latches 430 into sloped grooves 422 in disc 420. Spring ring 440 can be any type of spring, including spring ring, retaining ring, rubber o-ring and so on and so forth. It should be noted that it is possible to change spring ring/o-ring 440 by the user and thereby change the preset torque value.

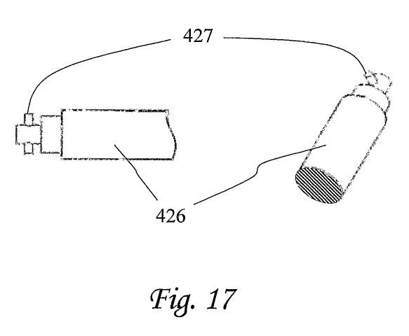

FIG. 17 illustrates the interface to the pre-calibrated torque mechanism, according to an embodiment of the present invention. Bearing 426 which is part of an altered “doriot” latch head 130 has a pin 427 that is operatively inserted in gap 421in disc 420.

Referring back to FIGS. 15 and 16 as well as to FIG. 17, the first disc 410, firmly attached to motor shaft 450 and turns with the motor shaft. Disc 410 owns two latches 430. The free ends of latches 430 are held by a retaining ring 440 in grooves 422 within torque disc 420, such that all rotate with the motor shaft as a single unit. But when the resistance from a screwed in screw 52, sensed by torque disc 420 through pin 427 that was inserted in gap 421, exceeds the pre-calibrated torque value, latches 430 (while pushing the retaining ring 440) get out (step 442) from sloped grooves 422. After the separation of discs 410 and 420, motor shaft turns without transferring more torque to screw 52. The preset torque value is achieved by a combination of the angle of slopes 422 and retaining ring 440 force. Latches 430 return 442 into grooves 422, only if the torque applied on torque disc 420 by pin 427 is again below the pre-calibrated torque value. If motor 450 is still activated, battery energy is preserved, since motor 450 is not “stuck”, but the clicking sound is an indication to stop it. Grooves 422 which are not symmetrical, allow latches 430 to get out above the preset torque only in forward direction of motor 450; thus rewind operation needed to open a tightened screw takes advantage of the full motor torque.

In embodiments of the present invention driver 100 is used for endodontic applications and/or for implantology.

The invention being thus described in terms of embodiments and examples, it will be obvious that the same may be varied in many ways. Such variations are not to be regarded as a departure from the spirit and scope of the invention, and all such modifications as would be obvious to one skilled in the art, are intended to be included within the scope of the following claims.

What is claimed is:

1-23. (canceled)

24. A contra angle driver for screwing a screw to fix an abutment to a dental implant, the driver comprising:
a motorized latch head for engaging to a driver tip for rotating the driver tip;
an abutment holder including fasteners for fastening the abutment holder to the driver and for fastening the abutment and preventing rotation of the abutment relative to the driver.

25. The driver of claim 24, further comprising a preset torque mechanism for terminating spin of the driver tip at a preset torque value;

26. The driver of claim 25, wherein said preset torque mechanism comprises two discs, two latches in grooves and a retaining ring, wherein said retaining ring holds said discs together defining, together with the shape of said grooves, a single preset torque value that when reached said latches overcome the force applied by said retaining ring thereby disengaging the two discs, causing a temporary disengagement of the latch head from driver motor.

27. The driver of claim 24, being a cordless driver.

28. The driver of claim 24, wherein the abutment holder is designed to hold the abutment at a predetermined distance from the latch head.

29. An abutment holder for use with a contra angle driver for screwing a screw to fix an abutment to a dental implant, the driver including a latch head for engaging to a driver tip, and a motor with gear mechanism for rotating the driver tip, the abutment holder comprising a body and including fasteners for fastening the abutment holder body to the driver and for fastening the abutment and preventing rotation of the abutment relative to the driver.

30. The abutment holder of claim 29, wherein one of the fasteners is designed to be detachably affixed to the latch head.

31. The abutment holder of claim 29, designed to hold the abutment at a predetermined distance from the latch head.

32. A method for screwing or unscrewing a screw to fix an abutment to a dental implant or disengage the abutment from the dental implant, the method comprising: using an abutment holder in cooperation with a contra angle driver to screw or unscrew the screw, the abutment holder fastened to the driver and to the abutment preventing rotation of the abutment relative to the driver.

33. An organizing device comprising a body with threaded holes for accommodating screwable dental items.

34. The device of claim 33, wherein the threaded holes are arranged in an arrangement simulating teeth positions in a mouth structure.
